(19) United States
(12) Patent Application Publication
(10) Pub. No.: US 2023/0221138 A1
(43) Pub. Date: Jul. 13, 2023

(54) SHIP NAVIGATION ASSISTANCE DEVICE, SHIP NAVIGATION ASSISTANCE METHOD, AND SHIP NAVIGATION ASSISTANCE PROGRAM

(71) Applicant: FURUNO ELECTRIC CO., LTD., Hyogo (JP)

(72) Inventors: Tatsuya SONOBE, Ikeda (JP); Hiroyuki TODA, Nishinomiya (JP); Hiraku NAKAMURA, Tokyo (JP); Kazuki TSUJIMOTO, Amagasaki (JP)

(73) Assignee: FURUNO ELECTRIC CO., LTD., Hyogo (JP)

(21) Appl. No.: 18/174,400

(22) Filed: Feb. 24, 2023

Related U.S. Application Data
(63) Continuation-in-part of application No. PCT/JP2021/026771, filed on Jul. 16, 2021.

(30) Foreign Application Priority Data
Aug. 24, 2020 (JP) 2020-140550

(51) Int. Cl. G01C 21/00; G01C 21/16

(52) U.S. Cl. CPC G01C 21/3844; G01C 21/1652

(57) ABSTRACT

The purpose of the present disclosure is to suppress an error which occurs in movement, such as in anchoring a ship. A ship navigation assistance system includes a measurement sensor and a characteristic information updating module. The measurement sensor acquires measurement information on an object using a ranging result of an area including the object that is an anchorage target of a ship. The characteristic information updating module updates characteristic information on the object using initial characteristic information on the object or characteristic information before updating on the object, and the measurement information.

### CROSS-REFERENCE TO RELATED APPLICATION(S)

This application is a continuation-in-part of PCT International Application No. PCT/JP2021/026771, which was filed on Jul. 16, 2021, and which claims priority to Japanese Patent Application No. 2020-140550 filed on Aug. 24, 2020, the entire disclosures of each of which are herein incorporated by reference for all purposes.

### TECHNICAL FIELD

The present disclosure relates to a ship navigation assistance technology which is used when anchoring a ship.

### BACKGROUND

In Patent Document 1, a docking assistance device for a ship is disclosed. The docking assistance device disclosed in Patent Document 1 uses a distance measurement means to measure a distance between the ship and a plurality of points of a quay.

### REFERENCE DOCUMENT(S) OF CONVENTIONAL ART

[Patent Document 1] JP5000244B2

### DESCRIPTION OF THE DISCLOSURE

However, the distance measured by the distance measurement means as described in the conventional technology contains an error. In addition, this error occurs in every measurement of the distance, and increases sequentially.

Thus, one purpose of the present disclosure is to suppress an error which occurs in movement, such as in anchoring a ship.

### SUMMARY

A ship navigation assistance system (a/k/a a ship navigation assistance system) according to the present disclosure includes a measurement sensor and a characteristic information updating module. The measurement sensor acquires measurement information on an object using a ranging result of an area including the object that is an anchorage target of a ship. The characteristic information updating module updates characteristic information on the object using initial characteristic information on the object or characteristic information before updating on the object, and the measurement information.

According to this configuration, the ranging result is reflected on characteristic information after updating.

According to the present disclosure, the error which occurs in movement, such as in anchoring a ship, can be suppressed.

### BRIEF DESCRIPTION OF DRAWINGS

FIG. 1 is a functional block diagram illustrating a configuration of a ship navigation assistance system according to one embodiment of the present disclosure.

FIG. 2 is a functional block diagram illustrating a configuration of a provisional initial information specifier.

FIG. 3 is a functional block diagram illustrating a configuration of a measurement sensor.

FIG. 4 is a functional block diagram illustrating a configuration of a characteristic information updating module.

FIG. 5 is a view illustrating one example of a method of specifying provisional initial information.

FIG. 6 is a graph illustrating one of the example settings of a weighting coefficient.

FIG. 7 is a functional block diagram illustrating one of the concrete example applications of the configuration of the ship navigation assistance system according to one embodiment of the present disclosure.

FIG. 8 is a view illustrating an updating concept of a quay line.

FIGS. 9A, 9B, and 9C are views illustrating an update state of the quay line.

FIGS. 10A and 10B are flowcharts illustrating outline processing of a ship navigation assistance method.

FIG. 11A is a flowchart illustrating a concrete process flow of the update of the characteristic information illustrated in FIG. 10A, and FIG. 11B is a flowchart illustrating a concrete process flow of the update of the quay line illustrated in FIG. 10B.

FIG. 12 is a flowchart illustrating another concrete process flow of the update of the characteristic information.

FIG. 13 is a flowchart illustrating another concrete process flow of the update of the characteristic information.

FIG. 14A is a flowchart illustrating processing of the ship navigation assistance method including generation of navigation assistance information, and FIG. 14B illustrates a case where the processing of FIG. 14A is set to a more concrete object (quay).

FIG. 15 is a functional block diagram illustrating a configuration of the ship navigation assistance system in an aspect in which the quay line and a quay reference point are calculated and updated.

FIGS. 16A, 16B, and 16C are views illustrating an update state of the quay line and the quay reference point.

FIG. 17 is a flowchart illustrating outline processing of a method of updating the quay line and the quay reference point.

FIG. 18 is a flowchart illustrating the method of updating the quay reference point.

FIG. 19 is a flowchart illustrating a processing which sets the provisional initial information based on positional coordinates of the past of the characteristic information on the object.

### DETAILED DESCRIPTION

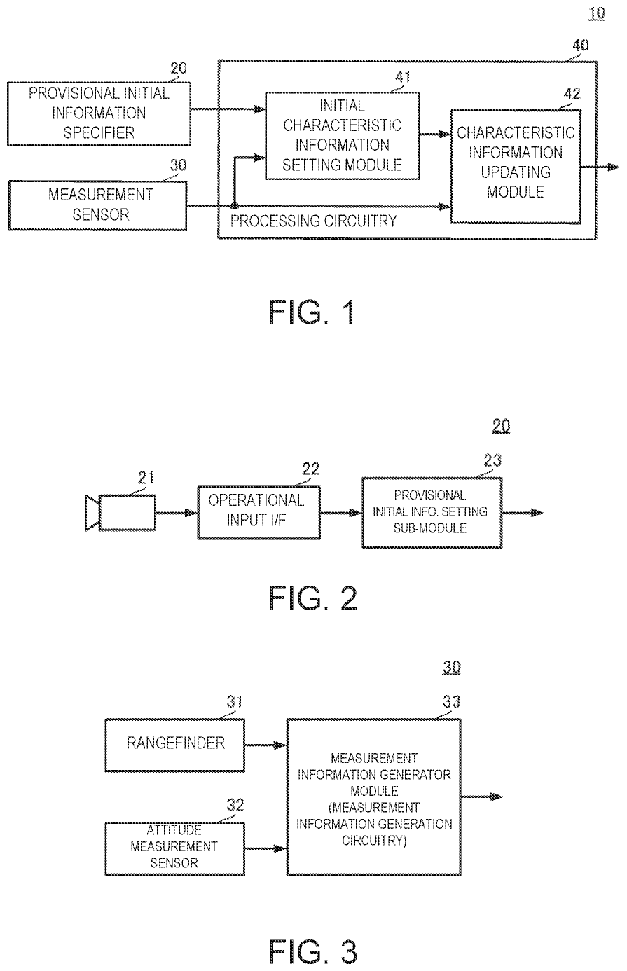

A ship navigation assistance technology according to one embodiment of the present disclosure is described with reference to the drawings. FIG. 1 is a functional block diagram illustrating a configuration of a ship navigation assistance system according to one embodiment of the present disclosure. FIG. 2 is a functional block diagram illustrating a configuration of a provisional initial information specifier. FIG. 3 is a functional block diagram illustrating a configuration of a measurement sensor.

### (Outline Configuration of Ship Navigation Assistance System 10)

As illustrated in FIG. 1, the ship navigation assistance system 10 may include a provisional initial information specifier 20, a measurement sensor 30, and processing circuitry 40. The ship navigation assistance system 10 may be realizable, for example, by a memory device which stores a program (ship navigation assistance program) for implementing a ship navigation assistance method, and processing circuitry, such as a CPU, for executing the ship navigation assistance program, except for optical-system modules and radio-wave-system modules. Further, the modules of the memory device and the processing circuitry may also be realized by an IC etc. in which the navigation assistance program is incorporated.

The provisional initial information specifier 20 may accept a specification of provisional initial information for characteristic information on an object to which a ship anchors or docks (docks to a pier). The provisional initial information specifier 20 may output the provisional initial information to the processing circuitry 40. For example, the object may be a quay (wall), the characteristic information may be a vector quantity of a quay line, or positional coordinates of a quay reference point, and the provisional initial information may be a provisional quay line (vector quantity) and a provisional quay reference point (positional coordinates).

The measurement sensor 30 may range or measure a distance to an area including the object to which the ship anchors or docks (docks to a pier). The measurement sensor 30 may acquire measurement information on the object using the ranging result. The measurement sensor 30 may output the measurement information to the processing circuitry 40. For example, the measurement information may be a vector quantity of a line segment (straight line).

The processing circuitry 40 may include an initial characteristic information setting module 41 and a characteristic information updating module 42. The provisional initial information may be inputted into the initial characteristic information setting module 41. The measurement information may be inputted into the initial characteristic information setting module 41 and the characteristic information updating module 42.

The initial characteristic information setting module 41 may set initial characteristic information using the provisional initial information and the measurement information. The initial characteristic information may be, for example, an initial quay line (vector quantity) and initial a quay reference point (positional coordinates).

In detail, for example, if the number of measurement information on the object is one, the initial characteristic information setting module 41 may set this measurement information as the initial characteristic information. If there are a plurality of measurement information on the object, the initial characteristic information setting module 41 may set the initial characteristic information based on the plurality of measurement information. For example, the initial characteristic information setting module 41 may detect measurement information (maximum likelihood measurement information) of which the position and the direction to the ship are most similar to the provisional initial information, among the plurality of measurement information. The initial characteristic information setting module 41 may set the maximum likelihood measurement information as the initial characteristic information. By performing such processing, the ship navigation assistance system 10 can suppress an error of the initial characteristic information, rather than when a user manually inputting the initial characteristic information. The initial characteristic information setting module 41 may output the initial characteristic information to the characteristic information updating module 42.

The characteristic information updating module 42 may update the characteristic information using the measurement information. For example, the characteristic information updating module 42 may update it to new characteristic information using the measurement information at a time point substantially the same as the setting timing of the initial characteristic information. Further, thereafter, the characteristic information updating module 42 may sequentially update the characteristic information using the acquired measurement information. Note that more detailed configuration and processing of the characteristic information updating module 42 will be described later.

By performing such processing, the characteristic information to be updated may be set based on the measurement information for every update. Therefore, even if the characteristic information is sequentially updated, an increase in the error can be suppressed. Therefore, for example, the ship navigation assistance system 10 can suppress an error which is contained in information to be acquired when the ship moves to the object (e.g., a spatial relationship, a distance, and a direction between the ship and the object). As a more concrete example, for example, it can suppress the errors contained in the distance and the direction between the ship and the quay line or the quay reference point in movement (docking), such as anchoring the ship.

### (Configuration of Provisional Initial Information Specifier 20)

As illustrated in FIG. 2, the provisional initial information specifier 20 may include a camera 21, an operational input interface 22, and a provisional initial information setting sub-module 23. The provisional initial information setting sub-module 23 can be implemented as provisional initial information setting circuitry.

The camera 21 may be connected to the operational input interface 22. The camera 21 may be, for example, a monocular camera, which images an area including the object (for example, a quay). The camera 21 may output the captured image to the operational input interface 22.

The operational input interface 22 may be, for example, realized by a touch panel. The operational input interface 22 may display the inputted image. The operational input interface 22 may accept an operational input from a user, and detect an operated position on the image (a locus of the operation). The operational input interface 22 may output the operated position (the locus of the operation) to the provisional initial information setting sub-module 23.

The provisional initial information setting sub-module 23 may convert the operated position (the locus of the operation) into a vector quantity in a three-dimensional coordinate system which is set to the image, and set up it as provisional initial information. The provisional initial information setting sub-module 23 may output the provisional initial information to the processing circuitry 40.

### (Concrete Example of Method of Specifying Provisional Initial Information)

FIG. 5 is a view illustrating one example of a method of specifying the provisional initial information. As illustrated in FIG. 5, the image including a quay 90 which is the object may be displayed on a display screen. When the user operates the touch panel with his/her finger so as to follow an actual quay line 910 displayed on the screen, the operational input interface 22 may detect the locus of the operation (a locus corresponding to a provisional quay line 920 in FIG. 5). In more detail, the operational input interface 22 may detect a group of pixels (a group of coordinates of the pixels) which are operated with the finger in the image, as the locus. The operational input interface 22 may output this locus to the provisional initial information setting sub-module 23.

The provisional initial information setting sub-module 23 may set this locus as the provisional quay line 920. The provisional quay line 920 may be expressed, for example, by a vector quantity which is set based on a direction and a distance on the basis of the position of the ship. The provisional quay line 920 may correspond to the provisional initial information. The provisional initial information setting sub-module 23 may output the provisional quay line 920 to the initial characteristic information setting module 41 of the processing circuitry 40.

### (Configuration of Measurement Sensor 30)

As illustrated in FIG. 3, the measurement sensor 30 may include a rangefinder 31, an attitude measurement sensor 32, and a measurement information generator module 33. The measurement information generator module 33 can be implemented as measurement information generation circuitry.

The rangefinder 31 may be realized by a LIDAR, for example Note that the rangefinder 31 may be a LADAR, or other distance measuring equipment, such as optical-based or radio-wave-based equipment. The rangefinder 31 may perform a three-dimensional ranging for the area including the object to detect a plurality of characteristic points. The rangefinder 31 may output the plurality of characteristic points to the measurement information generator module 33.

The attitude measurement sensor 32 may be, for example, realized by an attitude sensor provided to the ship. Note that the attitude sensor may use a positioning technique of GNSS signals, or may use an inertia sensor. Further, the attitude sensor may combine the positioning technique of the GNSS signals and the inertia sensor. When the positioning technique of the GNSS signals is used, the position (positional coordinates) of the ship can also be measured. Further, when the positioning technique of the GNSS signals is used, the attitude can be measured with high precision in an open-sky situation, like on the sea. The attitude measurement sensor 32 may measure the attitude of the ship. The attitude measurement sensor 32 may output the attitude of the ship to the measurement information generator module 33.

The measurement information generator module 33 may convert (project) the plurality of characteristic points obtained by three-dimensional coordinates into a two-dimensional coordinate system on a horizontal plane. Here, the measurement information generator module 33 can convert the plurality of characteristic points in the three-dimensional coordinate system into the two-dimensional coordinate system on the horizontal plane with high precision by utilizing the attitude of the ship, for example, even if the ship rolls or pitches.

The measurement information generator module 33 may apply a given conversion process (for example, a Hough conversion process) to the plurality of characteristic points disposed at the two-dimensional coordinates on the horizontal plane to generate the measurement information. The measurement information generator module 33 may output the generated measurement information to the initial characteristic information setting module 41 and the characteristic information updating module 42 of the processing circuitry 40. Note that the processing for converting the plurality of characteristic points obtained by the three-dimensional coordinates into the two-dimensional coordinate system on the horizontal plane can be omitted.

### (More Concrete Description of Processing Circuitry 40)

The processing circuitry 40 may include the initial characteristic information setting module 41 and the characteristic information updating module 42, as described above. The initial characteristic information setting module 41 is described above, and therefore, explanation thereof will be omitted below. The initial characteristic information setting module 41 may set the initial characteristic information using the provisional initial information and the measurement information, and output it to the characteristic information updating module 42.

### (Configuration and Processing of Characteristic Information Updating Module 42)

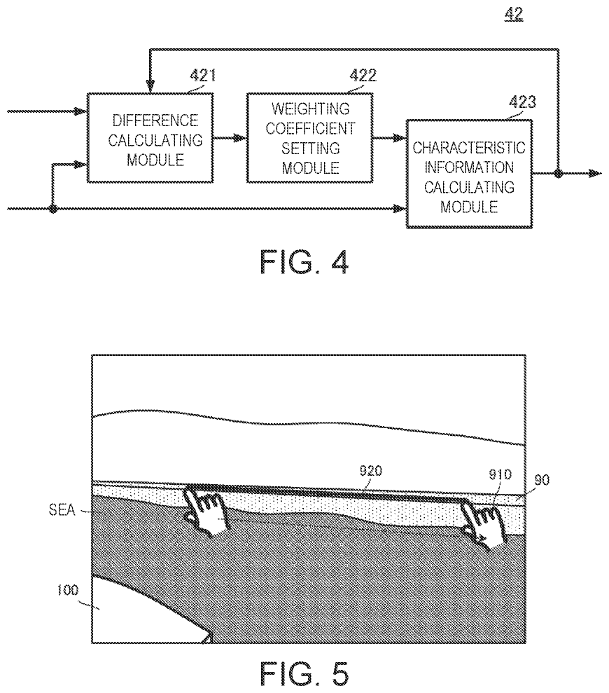

FIG. 4 is a functional block diagram illustrating a configuration of the characteristic information updating module. As illustrated in FIG. 4, the characteristic information updating module 42 may include a difference calculation module 421, a weighting coefficient setting module 422, and a characteristic information calculation module 423.

The difference calculation module 421 may calculate a difference between the characteristic information and the measurement information. In more detail, when the initial characteristic information is inputted into the difference calculation module 421, the difference calculation module 421 may calculate the difference between the initial characteristic information and the measurement information corresponding to this timing. Further, when the characteristic information updated by the characteristic information calculation module 423 is fed back to the difference calculation module 421, the difference calculation module 421 may calculate a difference between the fed-back characteristic information and the measurement information corresponding to the fed-back timing Note that the measurement information corresponding to the timing illustrated here indicates, for example, the measurement information acquired at a time point immediately after that timing.

When a plurality of measurement information are acquired, the difference calculation module 421 may calculate a difference between the initial characteristic information or the fed-back characteristic information (the characteristic information before updating) and the measurement information, for every plurality of measurement information. The difference calculation module 421 may output the difference for each measurement information to the weighting coefficient setting module 422.

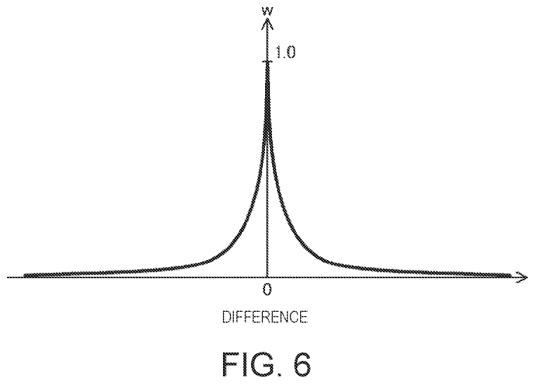

The weighting coefficient setting module 422 may set a weighting coefficient according to the difference for each measurement information. FIG. 6 is a graph illustrating one example of an example setting of the weighting coefficient. As illustrated in FIG. 6, the weighting coefficient may be set so that a weighting coefficient w becomes smaller as an absolute value of the difference becomes larger. The weighting coefficient setting module 422 may output the weighting coefficient w for each measurement information to the characteristic information calculation module 423.

The measurement information and the weighting coefficient w may be inputted into the characteristic information calculation module 423. The characteristic information calculation module 423 may calculate the characteristic information using the measurement information and the weighting coefficient w for this measurement information. In more detail, the characteristic information calculation module 423 may normalize the weighting coefficient w. The normalization as used herein is resetting the weighting coefficient w so that the sum total of adding up all the weighting coefficients becomes 1. Note that this normalization processing may be performed by the weighting coefficient setting module 422.

The characteristic information calculation module 423 may multiply the measurement information by the normalized weighting coefficient w. The characteristic information calculation module 423 may output a result of summing the measurement information by which the weighting coefficient w was multiplied, as new characteristic information (characteristic information after updating).

By such a configuration and processing, the updated characteristic information may be generated by the addition of the measurement information which used the ranging result. Therefore, the accumulation of the error by repeating the update is suppressed.

Further, the measurement information may be multiplied by the weighting coefficient. Then, the weighting coefficient may be set so that its influence to the updated characteristic information becomes smaller as the difference from the characteristic information before the update becomes larger. Therefore, the updated characteristic information becomes highly precise to the actual characteristic information, because the influence of the error contained in the characteristic information before updating is reduced.

Therefore, the ship navigation assistance system 10 is capable of generating the characteristic information which is highly precise to the actual characteristic information, while suppressing the updating error.

### (Concrete Example Application of Ship Navigation Assistance System 10)

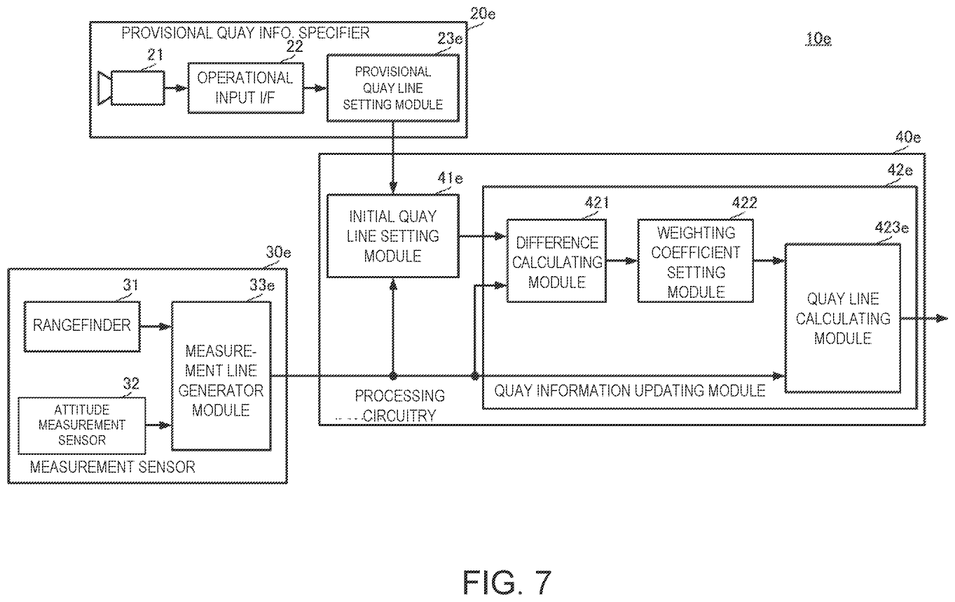

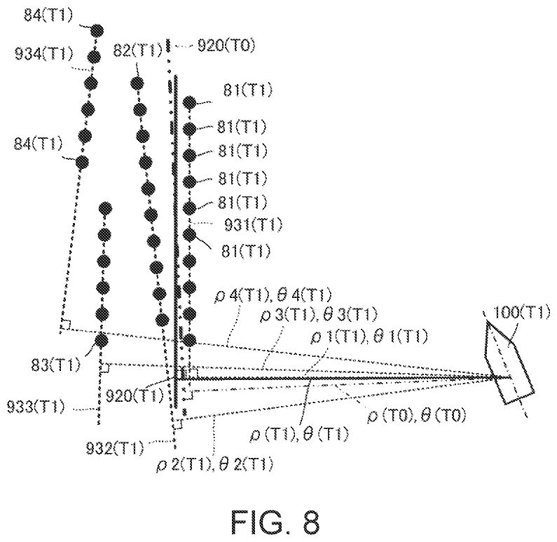

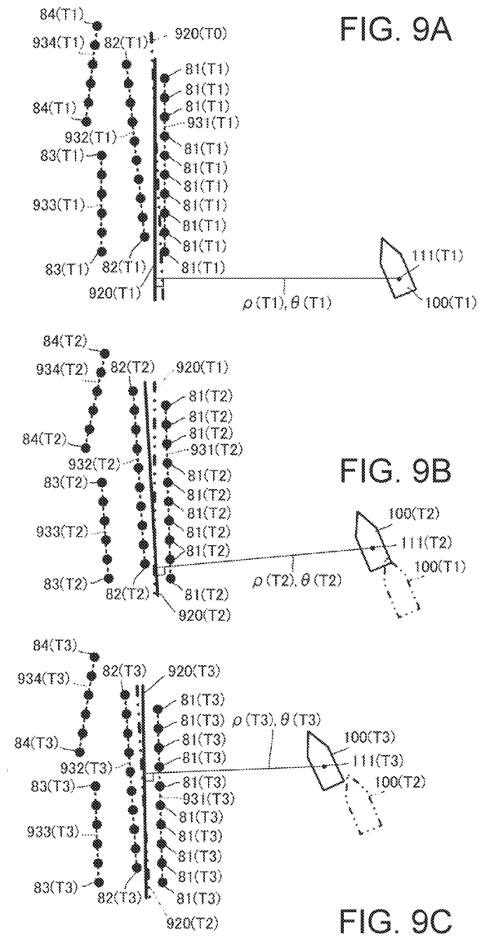

FIG. 7 is a functional block diagram illustrating one example of a concrete example application of the configuration of the ship navigation assistance system according to one embodiment of the present disclosure. Note that FIG. 7 is fundamentally similar to a drawing which combines FIG. 1, FIG. 2, FIG. 3, and FIG. 4, and differs in that the object, the characteristic information, etc. are embodied. Below, only modules which need additional explanation are described, and description of modules which can be understood from the above explanation is omitted. FIG. 8 is a view illustrating a concept of updating the quay line. FIGS. 9A, 9B, and 9C are views illustrating an update state of the quay line.

As illustrated in FIG. 7, the ship navigation assistance system 10e may include a provisional quay information specifier 20e, a measurement sensor 30e, and processing circuitry 40e. The provisional quay information specifier 20e corresponds to the above-described provisional initial information specifier 20. The measurement sensor 30e corresponds to the measurement sensor 30. The processing circuitry 40e corresponds to the processing circuitry 40.

The provisional quay information specifier 20e may include the camera 21, the operational input interface 22, and a provisional quay line setting sub-module 23e. The provisional quay line setting sub-module 23e corresponds to the provisional initial information setting sub-module 23, and can be implemented as provisional initial information setting circuitry, and may set a provisional quay line (see the provisional quay line 920 in FIG. 5 described above) using the operational input result. The provisional quay line setting sub-module 23e may output the provisional quay line to the processing circuitry 40e.

The measurement sensor 30e may include the rangefinder 31, the attitude measurement sensor 32, and a measurement line generating module 33e. The measurement line generating module 33e corresponds to the measurement information generator module 33, and can be implemented as measurement information generation circuitry, and may generate a straight measurement line using the plurality of characteristic points obtained by the ranging and the attitude of a ship 100. The measurement line may be represented by a distance p from a reference point (for example, a sensor position) 111 of the ship 100, and a direction θ of the measurement line on the basis of the position of the ship 100. As illustrated in FIG. 8, the distance p may be a length of a perpendicular line which is drawn from the ship 100 and is perpendicular to the measurement line, and the direction θ may be an angle formed between a reference direction in a given coordinate system and an extending direction of the perpendicular line. The measurement line generating module 33e may output the measurement line to the processing circuitry 40e.

The processing circuitry 40e may include an initial quay line setting module 41e and a quay information updating module 42e. The initial quay line setting module 41e corresponds to the initial characteristic information setting module 41, and the quay information updating module 42e corresponds to the characteristic information updating module 42.

The quay information updating module 42e may include the difference calculation module 421, the weighting coefficient setting module 422, and a quay line calculation module 423e. The quay line calculation module 423e corresponds to the characteristic information calculation module 423.

The provisional quay line and the measurement line may be inputted into the initial quay line setting module 41e. If the number of measurement lines is one, the initial quay line setting module 41e may set this measurement line as the initial quay line. If the number of measurement lines is two or more, the initial quay line setting module 41e may set a maximum likelihood measurement line among the plurality of measurement lines as the initial quay line. For example, the initial quay line setting module 41e may set the maximum likelihood measurement line, for example, as a measurement line with parameters most similar to the parameters (the distance p and the direction θ) of the provisional quay line. The initial quay line setting module 41e may output the initial quay line to the quay information updating module 42e.

The initial quay line and the measurement line may be inputted into the difference calculation module 421 of the quay information updating module 42e. The difference calculation module 421 may calculate a difference between each of the measurement lines and the initial quay line. Here, the difference calculation module 421 may calculate the difference for each parameter. That is, the difference calculation module 421 may calculate, for one measurement line, a difference Δρ of the distance ρ and a difference Δθ of the direction θ, with respect to the initial quay line.

For example, as illustrated in FIG. 8, for a quay line 920(T0) set at a timing T0, a plurality of measurement lines 931(T1), 932(T1), 933(T1), and 934(T1) measured at a timing T1 immediately after that may be obtained. The measurement line 931(T1) may be obtained at the timing T1, and may be generated from a plurality of characteristic points 81(T1) lined up straight. Similarly, the measurement line 932(T1) may be obtained at the timing T1, and may be generated from a plurality of characteristic points 82(T1) lined up straight. The measurement line 933(T1) may be obtained at the timing T1, and may be generated from a plurality of characteristic points 83(T1) lined up straight. The measurement line 934(T1) may be obtained at the timing T1, and may be generated from a plurality of characteristic points 84(T1) lined up straight. The difference calculation module 421 may output the difference for every measurement line to the weighting coefficient setting module 422.

The difference calculation module 421 may calculate a difference Δρ1(T1) between the distance ρ1(T1) of the measurement line 931(T1), and a distance ρ(T0) of the last quay line 920(T0). The difference calculation module 421 may calculate a difference Δθ1(T1) between the direction θ1(T1) of the measurement line 931(T1) and the direction θ(T0) of the last quay line 920(T0). Similarly, the difference calculation module 421 may calculate a difference Δρ2(T1) and a difference Δθ2(T1) for the measurement line 932(T1), calculate a difference Δρ3(T1) and a difference Δθ3(T1) for the measurement line 933(T1), and calculate a difference Δρ4(T1) and a difference Δθ4(T1) for the measurement line 934(T1). Then, the difference calculation module 421 may output these differences to the weighting coefficient setting module 422.

The weighting coefficient setting module 422 may set the weighting coefficients according to the differences. In more detail, the weighting coefficient setting module 422 may set a first weighting coefficient wρ for the distance ρ according to the difference Δρ of the distance p. The weighting coefficient setting module 422 may set a second weighting coefficient wθ for the direction θ according to the difference Δθ of the direction θ. The weighting coefficient setting module 422 may output the first weighting coefficient wρ and the second weighting coefficient wθ to the quay line calculation module 423e.

The quay line calculation module 423e may normalize the first weighting coefficient wρ using the number of measurement lines to be added, respectively. The quay line calculation module 423e may normalize the second weighting coefficient wθ using the number of measurement lines to be added, respectively.

The quay line calculation module 423e may multiply, for every measurement line, the distance ρ by the normalized first weighting coefficient wρ, and add up these multiplied values. For example, for the example of FIG. 8, the quay line calculation module 423e may multiply the distance ρ1(T1) of the measurement line 931(T1) by the first weighting coefficient wρ1, multiply the distance ρ2(T1) of the measurement line 932(T1) by the first weighting coefficient wρ2, multiply the distance ρ3(T1) of the measurement line 933(T1) by the first weighting coefficient wρ3, multiply the distance ρ4(T1) of the measurement line 934(T1) by the first weighting coefficient wρ4, and add up these multiplied values to calculate the distance ρ(T1) of the quay line 920(T1) at the timing T1.

The quay line calculation module 423e may multiply, for every measurement line, the direction θ by the normalized second weighting coefficient wθ, and add up these multiplied values. For example, for the example of FIG. 8, the quay line calculation module 423e may multiply the direction θ1(T1) of the measurement line 931(T1) by the second weighting coefficient wθ1, multiply the direction θ2(T1) of the measurement line 932(T1) by the second weighting coefficient wθ2, multiply the direction θ3(T1) of the measurement line 933(T1) by the second weighting coefficient wθ3, multiply the direction θ4(T1) of the measurement line 934(T1) by the second weighting coefficient wθ4, and add up these multiplied values to calculate the direction θ(T1) of the quay line 920(T1) at the timing T1.

By performing such processing, the quay line 920 may be updated sequentially as illustrated in FIGS. 9A, 9B, and 9C. For example, in FIG. 9A, the quay line 920(T1) at the timing T1 may be generated based on the measurement lines 931(T1), 932(T1), 933(T1), and 934(T1) at the timing T1, and the quay line 920(T0) at the last timing TO, and the quay line 920 may be updated. In FIG. 9B, a quay line 920(T2) at a timing T2 may be generated based on measurement lines 931(T2), 932(T2), 933(T2), and 934(T2) at the timing T2, and the quay line 920(T1) at the last timing T1, and the quay line 920 may be updated. In FIG. 9C, a quay line 920(T3) at a timing T3 may be generated based on measurement lines 931(T3), 932(T3), 933(T3), and 934(T3) at the timing T3, and the quay line 920(T2) at the last timing T2, and the quay line 920 may be updated.

Thus, by using the configuration of this embodiment, the ship navigation assistance system 10e can update the quay line 920 sequentially, and can suppress the accumulation of the updating error. Especially, by using this configuration and processing, as illustrated in FIGS. 9A, 9B, and 9C, the quay line 920 is updated using the ranging result at each timing, even if the ship 100 is moved. Therefore, the influence of the error due to the movement can also be reduced.

### (Ship Navigation Assistance Method)

In the above description, each processing may be performed by an individual functional module. However, the above processing can be implemented by being stored as a ship navigation assistance program and being executed by processing circuitry. In this case, the processing may be executed according to the flow illustrated in each of the following drawings. Note that, in the concrete contents of the processing in the following description, the detailed description of the above-described contents is omitted.

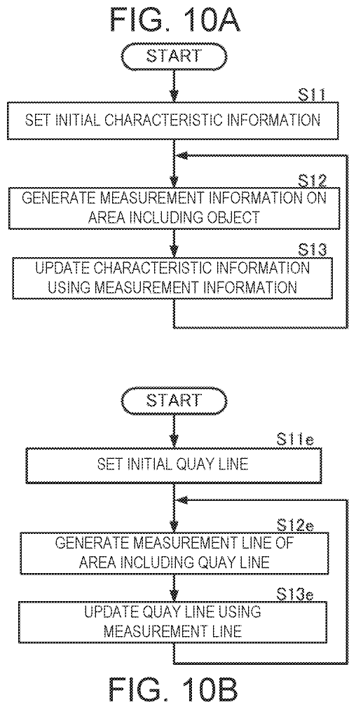

FIGS. 10A and 10B are flowcharts illustrating outline processings of the ship navigation assistance method. FIG. 10B illustrates a case where the processing of FIG. 10A is set for a more concrete object (quay).

As illustrated in FIG. 10A, the processing circuitry (the ship navigation assistance system) may set the initial characteristic information on the object (S11). The processing circuitry may generate the measurement information on the area including the object (S12). The processing circuitry may update the characteristic information by calculating new characteristic information from the initial information on the characteristic information on the object or the characteristic information before updating, and the measurement information (S13).

As a more concrete example, when the object is the quay, as illustrated in FIG. 10B, the processing circuitry may set the initial quay line (S11e). The processing circuitry may generate the measurement line of the area including the quay (S12e). The processing circuitry may update the quay line by calculating a new quay line from the initial quay line or the quay line before updating, and the measurement line (S13e).

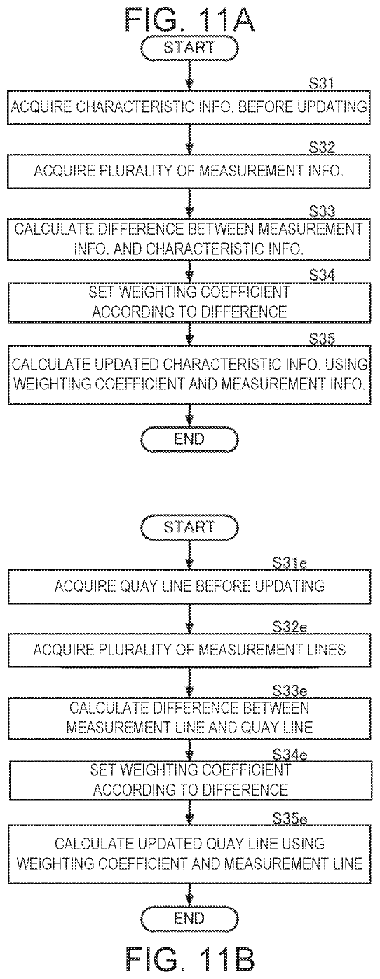

FIG. 11A is a flowchart illustrating a concrete process flow of the update of the characteristic information illustrated in FIG. 10A. FIG. 11B is a flowchart illustrating a concrete process flow of the update of the quay line illustrated in FIG. 10B.

As illustrated in FIG. 11A, the processing circuitry may acquire the characteristic information before updating, which includes the initial characteristic information (S31). The processing circuitry may acquire a plurality of measurement information (S32). The processing circuitry may calculate a difference between the measurement information and the characteristic information (S33). The processing circuitry may set, for each measurement information, the weighting coefficient according to the difference (S34). The processing circuitry may calculate the updated characteristic information using the weighting coefficient and the measurement information (S35).

As a more concrete example, when the object is the quay, as illustrated in FIG. 11B, the processing circuitry may acquire the quay line before updating, which includes the initial quay line (S31e). The processing circuitry may acquire a plurality of measurement lines (S32e). The processing circuitry may calculate a difference between the measurement line and the quay line (S33e). The processing circuitry may set, for every measurement line, the weighting coefficient according to the difference (S34e). The processing circuitry may calculate the updated quay line using the weighting coefficient and the measurement line (S35e).

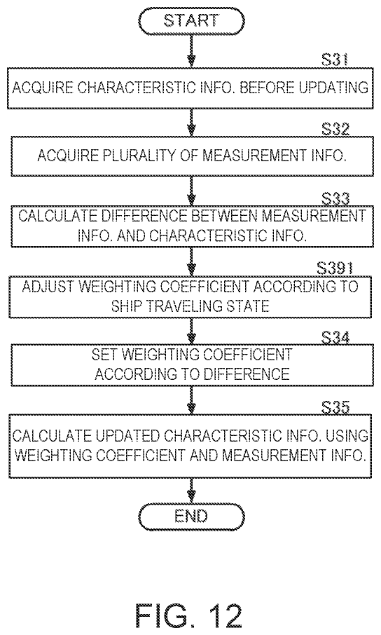

Note that the weighting coefficient may be adjusted according to a traveling state of the ship. FIG. 12 is a flowchart illustrating another concrete process flow of the update of the characteristic information. The processing illustrated in FIG. 12 differs from the processing illustrated in FIG. 11A in an adjustment processing of the weighting coefficient. Other processings illustrated in FIG. 12 are similar to the processing illustrated in FIG. 11A, and description of the similar modules is omitted.

As illustrated in FIG. 12, the processing circuitry may adjust the weighting coefficient according to the traveling state of the ship (S391). For example, the processing circuitry may reduce the reduction of the weight according to the difference as the ship becomes farther from the object. Further, the processing circuitry may reduce the reduction of the weight according to the difference as the traveling speed of the ship is faster (in more detail, for example, as the approaching speed to the object is faster). Note that these contents of the adjustment are examples, and, for example, the reduction of the weight may be reduced as the traveling state has a larger error contained in the ranging result and the measurement information.

By performing such processing, the ship navigation assistance systems 10 and 10e can update the characteristic information (for example, the quay line) with higher accuracy.

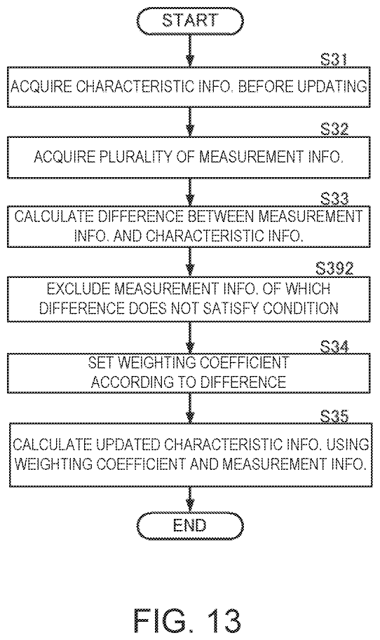

Further, in the above description, the acquired measurement information may be used for the update of the characteristic information as much as possible. However, the measurement information which does not satisfy a condition may not be used. FIG. 13 is a flowchart illustrating another concrete process flow of the update of the characteristic information. The processing illustrated in FIG. 13 differs from the processing illustrated in FIG. 11A in a selection processing of the measurement information. Other processings illustrated in FIG. 13 are similar to the processing illustrated in FIG. 11A, and description of the similar modules is omitted.

As illustrated in FIG. 13, the processing circuitry may exclude the measurement information of which the difference does not satisfy the condition (S392). This condition may be, for example, that the difference exceeds a threshold, in more detail, that the difference Δρ of the distance ρ exceeds a threshold for the distance, or that the difference Δθ of the direction θ exceeds a threshold for the direction.

By performing such processing, the ship navigation assistance systems 10 and 10e can eliminate, from the calculation of the characteristic information, the measurement information which has a bad influence to the calculation of the characteristic information (clearly far from the object, clearly different in shape, etc.).

By performing such processing, the characteristic information (quay line) can be updated continuously, for example, even if the measurement information (measurement line) is hardly acquired at a certain timing.

Further, the ship navigation assistance systems 10 and 10e may adopt an averaging processing of the characteristic information (e.g., a moving average). For example, the characteristic information calculation module 423 of the processing circuitry 40 may calculate the updated characteristic information by carrying out the averaging processing with weighting of the characteristic information before updating and the calculated characteristic information. Further, in more detail, the quay line calculation module 423e of the processing circuitry 40e may calculate the updated quay line by carrying out the averaging processing with weighting of the quay line before updating and the calculated quay line.

In this case, although the converging speed of the characteristic information by the update becomes slower by increasing the weight of the characteristic information (quay line) before updating, the influence by the error of the measurement information (measurement line) can be reduced. For example, if the ship is a large ship or a vessel, this is especially useful because the influence by the error is more important than the converging speed.

### (Method of Generating Navigation Assistance Information)

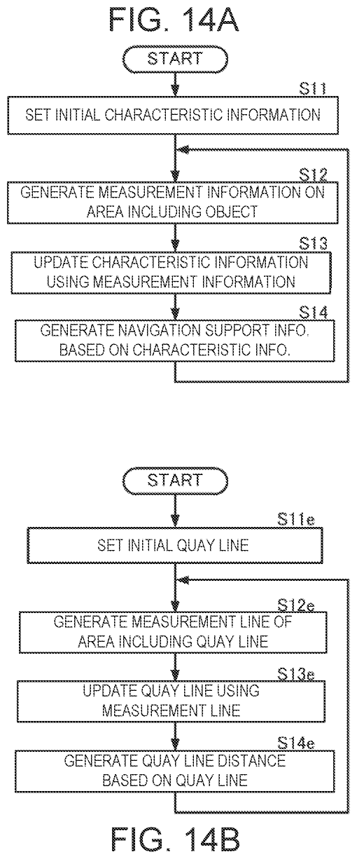

In the above description, the update and the output of the characteristic information (for example, the update and the output of the quay line) may be performed. However, the ship navigation assistance systems 10 and 10e can generate further navigation assistance information using the acquired characteristic information (for example, the quay line). FIG. 14A is a flowchart illustrating processing of the ship navigation assistance method including generation of the navigation assistance information. FIG. 14B illustrates a case where the processing of FIG. 14A is set for a more concrete object (quay). Note that the processing illustrated in FIG. 14A differs from the processing illustrated in FIG. 10A in that generation processing of navigation assistance information is added, and the processing illustrated in FIG. 14B differs from the processing illustrated in FIG. 10B in that generation of a quay line distance is added. Other processings of FIGS. 14A and 14B are similar to the processings illustrated in FIGS. 10A and 10B, respectively, and description of the similar modules is omitted.

As illustrated in FIG. 14A, the processing circuitry (the ship navigation assistance system) may generate the navigation assistance information based on the characteristic information (S14).

As a more concrete example, when the characteristic information is the quay line, as illustrated in FIG. 14B, the processing circuitry may generate the quay line distance based on the calculated (updated) quay line (S14e). The quay line distance may be obtained based on the distance ρ of the quay line, for example.

### (When Calculating and Updating Quay Line and Quay Reference Point)

In the above-described concrete description, the quay line may be calculated and updated. However, it is also possible to calculate and update other characteristic information related to the quay. Below, as other characteristic information, the quay reference point is calculated and updated. Note that the quay reference point is a reference point when the ship 100 docks, which is located on the quay line.

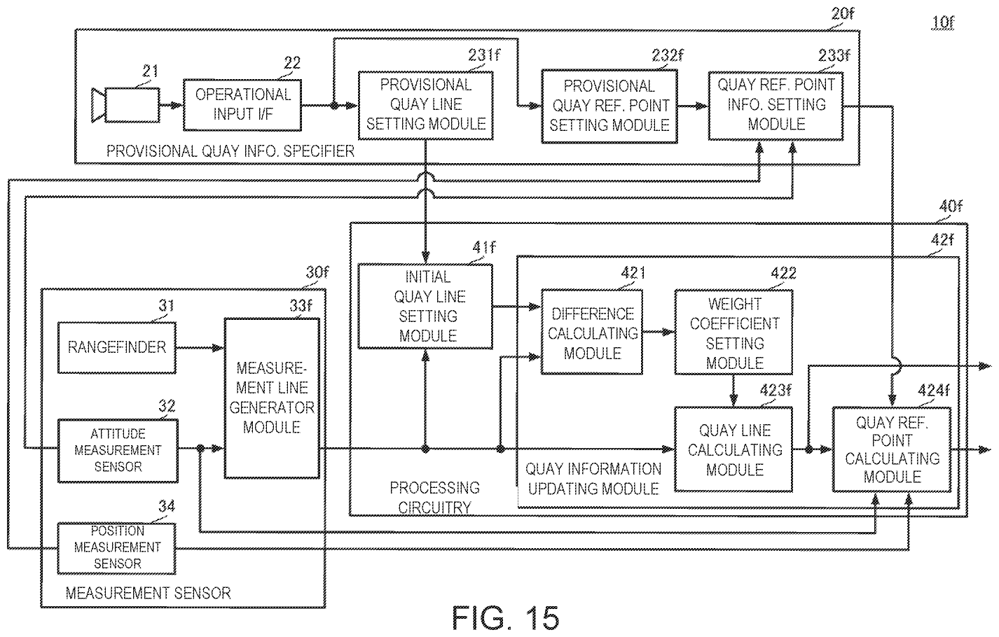

FIG. 15 is a functional block diagram illustrating a configuration of the ship navigation assistance system in which the quay line and the quay reference point are calculated and updated. Note that the ship navigation assistance system 10f illustrated in FIG. 15 differs from the ship navigation assistance system 10e illustrated in FIG. 7 in that a provisional quay reference point setting sub-module 232f, a quay reference point information setting sub-module 233f, a position measurement sensor 34, and a quay reference point calculation module 424f are further provided. Other configurations of the ship navigation assistance system 10f are similar to those of the ship navigation assistance system 10e, and description of the similar modules is omitted.

The ship navigation assistance system 10f may include a provisional quay information specifier 20f, a measurement sensor 30f, and processing circuitry 40f. The provisional quay information specifier 20f may include the camera 21, the operational input interface 22, a provisional quay line setting sub-module 231f, the provisional quay reference point setting sub-module 232f, and the quay reference point information setting sub-module 233f. The provisional quay line setting sub-module 231f may have a similar function to the provisional quay line setting sub-module 23e, and can be implemented as provisional initial information setting circuitry.

The measurement sensor 30f may include the rangefinder 31, the attitude measurement sensor 32, a measurement line generating module 33f, and the position measurement sensor 34. The measurement line generating module 33f may have a similar function to the measurement line generating module 33e and can be implemented as measurement information generation circuitry. The position measurement sensor 34 may have, for example, a positioning function of the GNSS, which measures the position of the ship 100.

The processing circuitry 40f may include an initial quay line setting module 41f and a quay information updating module 42f. The initial quay line setting module 41f may have a similar function to the initial quay line setting module 41e.

The quay information updating module 42f may include the difference calculation module 421, the weighting coefficient setting module 422, a quay line calculation module 423f, and the quay reference point calculation module 424f. The quay line calculation module 423f may have a similar function to the quay line calculation module 423e.

The update of the quay line is similar to that of the above-described ship navigation assistance system 10e, and description thereof is omitted.

### (Update of Quay Reference Point)

The provisional quay reference point setting sub-module 232f may set the provisional quay reference point using the operational input result. For example, the provisional quay reference point setting sub-module 232f may detect coordinates of an operated position on a screen, and set them as the provisional quay reference point. The provisional quay reference point setting sub-module 232f may output the provisional quay reference point to the quay reference point information setting sub-module 233f.

The quay reference point information setting sub-module 233f may calculate a direction ψ of the provisional quay reference point on the basis of the ship 100 using the provisional quay reference point, and the attitude of the ship 100 and the position of the ship 100. Then, the quay reference point information setting sub-module 233f may set the provisional quay reference point including this direction ψ as the initial quay reference point. The quay reference point information setting sub-module 233f may output the direction ψ of the initial quay reference point on the basis of the ship 100, which is indicated using the direction ψ, to the quay reference point calculation module 424f of the processing circuitry 40f.

The updated quay line, the initial quay reference point, the position of the ship 100, and the attitude of the ship 100 may be inputted into the quay reference point calculation module 424f. The quay reference point calculation module 424f may calculate a variation Δψ of the direction ψ using a variation in the position and a variation in the attitude of the ship 100 from the updating timing of the previous quay reference point. The quay reference point calculation module 424f may correct the direction ψ of the initial quay reference point or the direction ψ before updating by the variation Δψ, and update the direction ψ.

The quay reference point calculation module 424f may calculate an intersection between a straight line indicated by the updated direction ψ, and the updated quay line. The quay reference point calculation module 424f may calculate coordinates of the updated quay reference point based on the distance between the intersection and the ship 100, and the position of the ship 100. Thus, the quay reference point calculation module 424f may update the quay reference point.

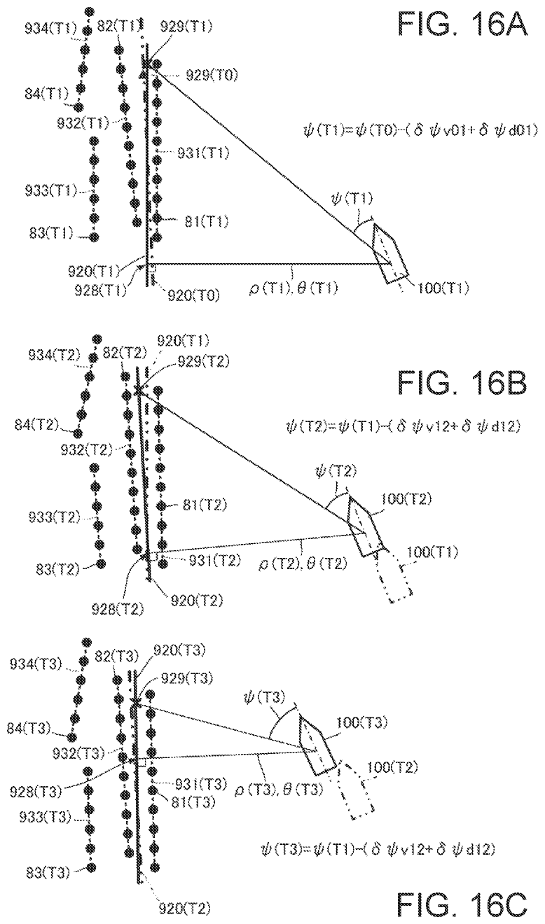

By using such a configuration and processing, for example, as illustrated in FIGS. 16A, 16B, and 16C, the quay reference point can be updated together with the quay line. FIGS. 16A, 16B, and 16C are views illustrating an update state of the quay line and the quay reference point.

First, in FIG. 16A, the initial quay line 920(T0) may be updated to the quay line 920(T1), and in connection with this, an initial quay reference point 929(T0) may be updated to a quay reference point 929(T1). The update of the quay reference point in this case, i.e., a direction ψ (T1) of the quay reference point 929(T1) may be obtained by correcting a direction ψ (T0) of the initial quay reference point 929(T0) by a direction variation Δψv01 due to the change in the position of the ship, and a direction variation Δψd01 due to the change in the attitude. Then, the positional coordinates of the quay reference point 929(T1) can also be calculated by obtaining the direction ψ (T1) of this quay reference point 929(T1), and the quay line 920(T1).

In FIG. 16B, the quay line 920(T1) may be updated to the quay line 920(T2), and in connection with this, the quay reference point 929(T1) may be updated to a quay reference point 929(T2). The update of the quay reference point in this case, i.e., a direction ψ (T2) of the quay reference point 929(T2) may be obtained by correcting the direction ψ (T1) of the quay reference point 929(T1) by a direction variation Δψv12 due to the change in the position of the ship and a direction variation Δψd12 due to the change in the attitude. Then, the positional coordinates of the quay reference point 929(T2) can also be calculated by obtaining the direction ψ (T2) of this quay reference point 929(T2), and the quay line 920(T2).

In FIG. 16C, the quay line 920(T2) may be updated by the quay line 920(T3), and in connection with this, the quay reference point 929(T2) may be updated to a quay reference point 929(T3). The update of the quay reference point in this case, i.e., a direction ψ (T3) of the quay reference point 929(T3) may be obtained by correcting the direction ψ (T2) of the quay reference point 929(T2) by a direction variation Δψv23 due to the change in the position of the ship and a direction variation Δψd23 due to the change in the attitude. Then, the positional coordinates of the quay reference point 929(T3) can also be calculated by obtaining the direction ψ (T3) of this quay reference point 929(T3), and the quay line 920(T3).

### (Method of Updating Quay Line and Quay Reference Point)

In the above description, each processing may be executed by the individual functional module. However, the above processing can be realized by being stored as a ship navigation assistance program and being executed by processing circuitry. In this case, the processing may be executed according to the flow illustrated in each of the following drawings. Note that, in the concrete contents of the processing in the following description, the detailed description of the above-described contents is omitted.

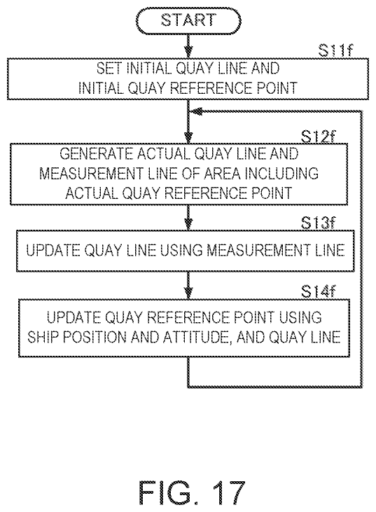

FIG. 17 is a flowchart illustrating outline processing of a method of updating the quay line and the quay reference point. As illustrated in FIG. 17, the processing circuitry (the ship navigation assistance system) may set the initial quay line and the initial quay reference point (S11f). The processing circuitry may generate an actual quay line, and a measurement line of the area including an actual quay reference point (S12f). The processing circuitry may update the quay line using the measurement line (S13f). The processing circuitry may update the quay reference point using the position and the attitude of the ship 100, and the updated quay line (S14f).

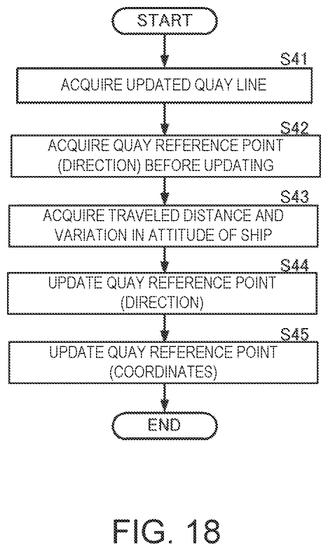

FIG. 18 is a flowchart illustrating a method of updating the quay reference point. As illustrated in FIG. 18, the processing circuitry (the ship navigation assistance system) may acquire the updated quay line (S41). The processing circuitry may acquire a direction of the quay reference point before updating (for example, the quay reference point on the basis of the ship 100) (S42).

The processing circuitry may acquire a traveled distance (a variation in the position) and a variation in the attitude of the ship 100 (S43). The processing circuitry may update the quay reference point (direction) using the direction of the quay reference point before updating, and the traveled distance (the variation in the position) and the variation in the attitude of the ship 100 (S44). The processing circuitry may update the quay reference point (positional coordinates) using the updated quay reference point (direction) and the updated quay line (S45).

By using such processing, the ship navigation assistance system 10f can suppress the error in the update of the quay reference point, as well as the update of the quay line.

### (Another Method of Setting Provisional Initial Information (Provisional Quay Line))

In the above explanation, the provisional initial information (provisional quay line) may be set by the user's operational input. However, it is also possible to set the provisional initial information based on the past data of the characteristic information on the object.

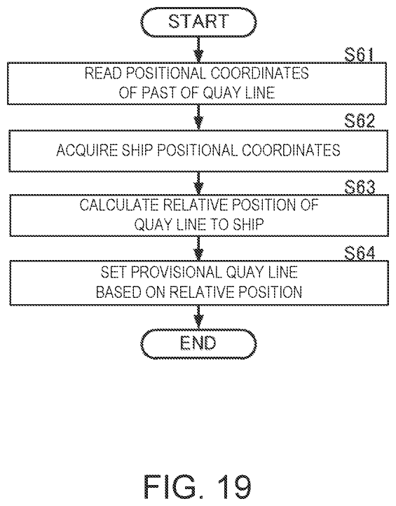

FIG. 19 is a flowchart illustrating a processing which sets the provisional initial information based on the positional coordinates of the past of the characteristic information on the object. Note that, here, the characteristic information on the object is the quay line, and the provisional initial information is the provisional quay line.

The processing circuitry may store the positional coordinates of the past of the quay line. The processing circuitry may read the positional coordinates of the past of the quay line (S61). The processing circuitry may acquire the positional coordinates of the ship (which anchors or docks to the object) (S62). The acquisition of the positional coordinates of the ship may be realizable, for example, by using the above-described positioning technique of the GNSS signals.

The processing circuitry may calculate a relative position of the quay line with respect to the ship by using these positional coordinates (S63). The processing circuitry may set the provisional quay line based on the relative position (S64). For example, the processing circuitry may convert the relative position into a vector quantity set by a distance and a direction on the basis of the ship, and set the provisional quay line.

Note that, here, the positional coordinates of the past of the quay line may be used. However, it is also possible to set a reference station to the quay line and a mobile station to the ship, to detect the relative position by using the technologies of DGPS or RTK, and to set the provisional quay line. Further, it is also possible to receive the coordinates of the quay line from external equipment and set the provisional quay line.

Moreover, in the above description, the initial information is set based on the measurement information, while using the provisional initial information as the reference. However, the provisional initial information may be set as the initial information as it is. Especially, when the above-described positioning technique of the GNSS signals is used, since the provisional initial information is less in the errors, it may be used for the initial information as it is.

Further, in the above description, the example in which the quay is the object is illustrated. However, as long as the object is a pier, another ship, etc., which is an object to which the ship anchors, the above-described configuration and processing are applicable.

Further, in the above description, the example in which the straight line (line segment) is used as the characteristic information is illustrated. However, it is also possible to use a point, a surface, or a curve as the characteristic information, and, also in these cases, the above-described configuration and processing are applicable.

### DESCRIPTION OF REFERENCE CHARACTERS

10, 10e, 10f: Ship Navigation Assistance System Device)
20: Provisional Initial Information Specifier
20e, 20f: Provisional Quay Information Specifier
21: Camera
22: Operational Input Interface
23: Provisional Initial Information Setting Sub-Module
23e: Provisional Quay Line Setting Module
30, 30e, 30f: Measurement Sensor
31: Rangefinder
32: Attitude Measurement Sensor
33: Measurement Information Generator Module
33e, 33f: Measurement Line Generator Module
34: Position Measurement Sensor
40, 40e, 40f: Processing Circuitry
41: Initial Characteristic Information Setting Module
41e, 41f: Initial Quay Line Setting Module
42: Characteristic Information Updating Module
42e, 42f: Quay Information Updating Module
81, 82, 83, 84: Characteristic Point
90: Quay
100: Ship (Vessel)
231f: Provisional Quay Line Setting Module
232f: Provisional Quay Reference Point Setting Module
233f: Quay Reference Point Information Setting Module
421: Difference Calculation Module
422: Weighting Coefficient Setting Module
423: Characteristic Information Calculation Module
423e, 423f: Quay Line Calculation Module
424f: Quay Reference Point Calculation Module
910: Actual Quay Line
920: Quay Line
929: Quay Reference Point
931, 932, 933, 934: Measurement Line

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

1. A ship navigation assistance system, comprising:
a measurement sensor configured to acquire measurement information on an object using a ranging result of an area including the object that is an anchorage target of a ship; and
processing circuitry configured to update characteristic information on the object using initial characteristic information on the object or characteristic information before updating on the object, and the measurement information.

2. The ship navigation assistance system of claim 1, wherein the processing circuitry is further configured:
to calculate a difference between the initial characteristic information or the characteristic information before updating and each of a plurality of measurement information;
to set a weighting coefficient to each of the plurality of measurement information using the difference; and
to calculate updated characteristic information using the weighting coefficient and the plurality of measurement information.

3. The ship navigation assistance system of claim 2, wherein the processing circuitry is further configured to set, as the weighting coefficient,
a first weighting coefficient set to a distance between the object and the ship, and
a second weighting coefficient set to a direction of the object on the basis of the ship, and
to calculate the updated characteristic information using the first weighting coefficient and the second weighting coefficient.

4. The ship navigation assistance system of claim 2, wherein the processing circuitry is further configured to calculate the updated characteristic information using the characteristic information before updating and the calculated characteristic information.

5. The ship navigation assistance system of claim 1, wherein the measurement sensor is further comprising:
a rangefinder configured to perform three-dimensional ranging of the area including the object; and
measurement information generation circuitry configured to generate the measurement information using a result of the three-dimensional ranging.

6. The ship navigation assistance system of claim 5, wherein the rangefinder is further comprising an optical rangefinder.

7. The ship navigation assistance system of claim 5, wherein the measurement sensor is further comprising an attitude measurement sensor configured to measure an attitude of the ship, and
wherein the measurement information generation circuitry is further configured to generate the measurement information using the result of the three-dimensional ranging and the attitude.

8. The ship navigation assistance system of claim 1, wherein the characteristic information on the object is a vector quantity determined by a spatial relationship between the ship and the object.

9. The ship navigation assistance system of claim 8, wherein the object is a quay, and the characteristic information on the object contains a quay line comprised of the vector quantity.

10. The ship navigation assistance system of claim 9, wherein the characteristic information on the object contains coordinates of a quay reference point.

11. The ship navigation assistance system of claim 10, wherein the measurement sensor is further comprising a position measurement sensor configured to measure a position of the ship, and
wherein the processing circuitry is further configured to update the quay reference point using the attitude and the position of the ship, and the quay line.

12. The ship navigation assistance system of claim 1, further comprising:
a provisional initial information specifier configured to accept a specification of provisional initial information for the characteristic information on the object; wherein:
the processing circuitry is further configured to set the initial characteristic information on the object using the provisional initial information and the measurement information.

13. A ship navigation assistance method, comprising:
acquiring, using a ranging result of an area including an object that is an anchorage target of a ship, measurement information on the object; and
updating characteristic information on the object using initial characteristic information on the object or characteristic information before updating on the object, and the measurement information.

14. A non-transitory computer readable medium storing instruction that, when executed by processing circuitry, cause a computer system to perform a method comprising:
acquiring, using a ranging result of an area including an object that is an anchorage target of a ship, measurement information on the object; and
updating characteristic information on the object using the initial characteristic information on the object or the characteristic information before updating on the object, and the measurement information.

15. The ship navigation assistance system of claim 3, wherein the processing circuitry is further configured to calculate the updated characteristic information using the characteristic information before updating and the calculated characteristic information.

16. The ship navigation assistance system of claim 2, wherein the measurement sensor is further comprising:
a rangefinder configured to perform three-dimensional ranging of the area including the object; and
measurement information generation circuitry configured to generate the measurement information using a result of the three-dimensional ranging.

17. The ship navigation assistance system of claim 3, wherein the measurement sensor is further comprising:
a rangefinder configured to perform three-dimensional ranging of the area including the object; and
measurement information generation circuitry configured to generate the measurement information using a result of the three-dimensional ranging.

18. The ship navigation assistance system of claim 4, wherein the measurement sensor is further comprising:
a rangefinder configured to perform three-dimensional ranging of the area including the object; and
measurement information generation circuitry configured to generate the measurement information using a result of the three-dimensional ranging.

19. The ship navigation assistance system of claim 16, wherein the rangefinder is further comprising an optical rangefinder.

20. The ship navigation assistance system of claim 17, wherein the rangefinder is further comprising an optical rangefinder.
